(19) United States
(12) Patent Application Publication
(10) Pub. No.: US 2009/0235830 A1
(43) Pub. Date: Sep. 24, 2009

(54) Vegetable peeler

(76) Inventor: Iwan Rasa, Pfyn (CH)

Correspondence Address: HARNESS, DICKEY & PIERCE, P.L.C., P.O. BOX 8910, RESTON, VA, 20195, US

(21) Appl. No.: 11/921,307

(22) PCT Filed: May 24, 2006
(86) PCT No.: PCT/CH2006/000274

§ 371 Date: Feb. 25, 2008

(30) Foreign Application Priority Data
Jun. 7, 2005 (CH) 965/05

(51) Int. Cl. A23N 7/00

(52) U.S. Cl. 99/588

(57) ABSTRACT

A vegetable peeler having a holder and a peeling knife supported by the holder, which includes a cutting edge extending in a longitudinal direction, a cutting gap and an engagement line. The engagement line formed at a side of the cutting gap opposite the cutting edge and a peeling direction, during peeling, being directed from the cutting edge toward the engagement line. The vegetable peeler may also include a deviation surface which, during the peeling procedure, in peeling direction, is behind the peeling knife at least in part, which extends at least over a middle longitudinal range, of the peeling knife, and an exit area so that pieces of peel cut-off are forward deviated by the deviation surface, when seen in peeling direction, and fall through the exit area out of the vegetable peeler.

### PRIORITY PARAGRAPH

This application is the national phase under 35 U.S.C. § 371 of PCT International Application No. PCT/CH2006/000274 which has an International filing date of May 24, 2006, which designated the United States of America and which claims priority on Swiss Patent Application number CH 965/05 filed Jun. 7, 2005, the entire contents of which are hereby incorporated herein by reference.

### BACKGROUND

1. Field

Embodiments of the invention generally relate to vegetable peelers.

2. Background

Vegetable peelers are known for many decades. They exist in various embodiments, such as those where the peeling knife is formed as a pendulum blade, or those having a fixed blade. Such vegetable peelers are either one-sidedly held on a shank, similar to a knife, or are held at both sides between lateral surfaces. The lateral surfaces of the knives held at both sides, in most cases, are interconnected in the shape of a yoke, this connection forming a handle. Shanks or yoke-shaped handles form the holders where the peeling knives are supported. The peeling knives comprise each a cutting edge, a cutting gap and an engaging line, the engaging line being formed at that side of the cutting gap, which is opposite the cutting edge. Optionally, the engaging line too is formed as a cutting edge so that the peeling knife may be used in two opposing directions for peeling, wherein one cutting edge is cutting, while the other one serves as an engaging line.

From documents U.S. Pat. No. 2,252,094, U.S. Pat. No. 2,351,327 and U.S. Pat. No. 3,956,825, vegetable peelers are known, the peeling knives of which are held at one side only and are connected to a handle. The movements necessary for an aimed guidance of the peeling knife, due to the lever arm formed by the handle, are relative large. This, during peeling, leads to quick fatigue.

Vegetable peelers having pendulum blades, which are supported at both ends, are known, for example, from U.S. Pat. No. 2,986,813 and U.S. Pat. No. 5,865,110. With these vegetable peelers also, the movements necessary for peeling are energy wasting.

From WO 03/070070, a vegetable peeler is known which comprises two lateral gripping surfaces, whereby the position of the knife can be changed already with a small movement.

Now, it has been found that with conventional vegetable peelers and at least some vegetables or even fruits, some additional movements have to be carried out either with the vegetable and/or the fruit or with the vegetable peeler, because pieces of peel already peeled off disturb the further operation. Particularly when peeling long vegetables, such as cucumbers or carrots, separated pieces of peel will then lie on the vegetable to be peeled. In the case of high moisture, for example of cucumbers, the peel cut-off may adhere strongly to the vegetable.

At an exhibition, a soap-bowl-shaped vegetable peeler has already been presented which receives the peel cut-off in the interior of the bowl. The peeler knife is arranged at the center on a large, flat lower side of the bowl. Although the peel cut-off does no longer lie on the vegetable, this vegetable peeler is extremely impractical. On the one hand, one does not see the vegetable region to be peeled during peeling work and, on the other hand, the bowl has often to be opened, emptied and closed again.

### SUMMARY

Within the frame of at least one embodiment of the invention, one recognized that the peel cut-off can be removed in peeling direction in front of the peeling knife without affecting the peeling procedure. When doing this, the peel falls down-wards in peeling direction in front of the peeling knife and beside the vegetable, and the vegetable remains free of peel. The peeling direction is the direction in which the vegetable peeler is moved when peeling, and is, thus, also the direction to which the cutting edge of the peeling knife points. When peeling, the peeling knife is positioned in such a way that the peeling direction of the cutting edge is oriented against the engagement line.

When providing a deviation surface which during peeling procedure is at least partially behind the cutting edge, the peel cut-off or the peeled material, seen in peeling direction, can be deviated forwards. At least a middle region of the deviation surface, but preferably the whole width of it, joins the peeling knife and prevents that the peel lies onto the vegetable or the fruit behind the peeling knife, seen in peeling direction. The vegetable peeler comprises before the peeling knife, when seen in peeling direction, an exit region so that pieces of peel cut-off are forwards deviated in peeling direction by the deviation surface and fall through the exit region out of the vegetable peeler.

To ensure a safe and complete deviation of a detached strip of peel, the deviation surface, in peeling direction behind the peeling knife, has to join it and has to extend itself over a sufficiently large area. The deviation surface is optionally connected to the peeling knife, or is separated from the peeling knife. At the transition form the peeling knife to the deviation surface, a joining line is formed on the deviation surface. If a small spaced gap is formed between the peeling knife and the deviation surface, the joining line is formed on that rim of the deviation surface which faces the peeling knife.

The peeling knife comprises a cutting edge, a cutting gap and an engagement line, the engagement line being formed at the side of the cutting gap opposite the cutting edge. The axis of the peeling knife extends in longitudinal direction of the peeling knife and, thus, substantially parallel to the cutting edge. When peeling, the peeling knife is substantially positioned in a peeling plane. The engagement line, prior to detaching a piece of peel, engages directly the free surface of that piece of peel, and the cutting edge is at the lower side of the detached piece of peel. When moving the peeling knife in peeling direction, the piece of peel is lifted from the vegetable or the fruit by the cutting edge, and reaches the joining line of the deviation surface through the cutting gap.

If a gap is formed between the peeling knife and the joining line, this gap will be chosen to be narrow. The joining line, during peeling operation, is in the region of the peeling plane or about in a region of a peeling knife plane extending through the cutting edge and the engagement line so that the detached piece of peel reaches the deviation surface via the joining line. With the current cutting edges, the detached peel is deviated a bit in upward direction in the region of the peeling knife. This transfer orientation corresponds substantially to the orientation of a guiding surface which leads away from the cutting edge. When a free peel front abuts the deviation surface, it must be deviated further upwards. To prevent any deviation downwards, that angle between the guiding surface and the deviation surface which is open to the front side and upwards, where a free peel front abuts the deviation surface, is at least somewhat larger than 90°. With a small gap between the peeling knife and the joining line or with a short distance between the cutting edge and that line where a free peel front abuts the deviation surface, the orientation of the peel corresponds substantially to the orientation of the guiding surface. If the guiding surface is concave in upward direction or curved in upward direction, the orientation of the guiding surface corresponds substantially to the orientation of the rear end region of the guiding surface in peeling direction. An angle between the deviation surface and the guiding surface, when peeling, depends also upon the orientation chosen of the holder or of the deviation surface. Correspondingly, the above-mentioned angle for the possible orientations of the holder, when peeling, should be larger than 90°.

The deviation surface extends from the joining line up to an exit line turned away from the former. In a region between the joining line and the exit line, the deviation surface comprises that area where the peel abuts after having been detached by the cutting-edge of the peeling knife. The orientation and the shape of the deviation surface is chosen in such a manner that the portion of the peel front, which abuts against the deviation surface, is deviated in upward direction and subsequently ahead in peeling direction. The position of the joining line relative to the cutting edge ensures that no piece of peel can reach behind the peeling knife the fruit to be peeled. Preferably, the deviation surface, in cross-sectional planes oriented transversely to the cutting edge of the peeling knife, is concave towards the peeling knife.

In order to prevent sticking of pieces of peel at the deviation surface, antifriction elements are optionally arranged or formed on the deviation surface. Preferably, fins, grooves or indentations are formed, which extends transversely to the cutting edge.

Vegetable peelers having a deviation surface enable peeling at a minimum of expenditure of energy. The detached peels do not remain on the product to be peeled. One can do without any movement of shaking or pushing off pieces of peel. Since the pieces of peel are not retained in a reception area, emptying can be omitted.

The deviation surface may either be connected directly to the peeling knife, or it may be separated and be connected to the peeling knife holder. In this way, a variety of vegetable peelers having a deviation surface can be developed to form a vegetable peeler according to the invention. With most of the vegetable peelers, a vegetable peeler can be obtained when inserting a peeling knife or a julienne knife having a deviation surface attached. Since the deviation surface may, in some cases, alter the pivoting behavior of a pendulum peeling knife relative to the holder, stops have to be readjusted for peeling knives having a deviation surface.

According to another embodiment, not shown in detail, the engagement line of the blade is formed as an additional cutting edge so that the peeling knife may be used in two opposite directions for peeling. In this way, the blade works, on the one hand, like a conventional vegetable peeler and, on the other hand, like a vegetable peeler according to the invention having a deviation surface.

A preferred vegetable peeler, apart from the deviation surface, comprises also the characteristics of a vegetable peeler according to WO 03/070070 A1, the entire contents of which are hereby incorporated herein by reference. In this case, the deviation surface is preferably formed as a part of the holder and interconnects two lateral gripping surfaces. The peeling knife is pivotally supported at the lateral gripping surfaces. With such a vegetable peeler, the extension of the holder in peeling direction is shorter than the distance between the two gripping surfaces. Due to the small dimension of the holder in peeling direction, even with a small movement, the knife's position may remarkably be changed. The deviation surface and the gripping surfaces are preferably integrally formed of metal or plastic material. A concave deviation surface confers high stability to the holder and prevents any disorientation of the gripping surfaces. The peeling knife is preferably formed as a pendulum blade pivotally supported at the gripping surfaces. As preferred, a gripping dell is formed on each gripping surface.

According to another variant, not shown, a cut out arrangement of one of the known shapes may be formed or arranged on the gripping surfaces.

### BRIEF DESCRIPTION OF THE DRAWINGS

In the following, embodiments of the subject of the invention are described in detail with reference to the drawings, the characteristics described or illustrated forming the subject matter of the invention either each individually or in any combination, independently from their combination or dependencies of the claims. It is shown in

FIG. 1 a perspective representation of a manually held vegetable peeler,

FIG. 2 a bottom view of the vegetable peeler,

FIG. 3 a cross-section of a vegetable peeler during peeling,

FIG. 4 a view onto the holder, in peeling direction, from behind,

FIG. 5 a front view of the holder, when seen in peeling direction,

FIG. 6 a cross-section of a vegetable peeler during peeling,

FIG. 7 a perspective view of a vegetable peeler, where the deviation surface is connected to the peeling knife,

FIG. 8 a top view onto the peeling knife including the deviation surface, and

FIG. 9 a bottom view of the peeling knife including the deviation surface.

### DETAILED DESCRIPTION OF EXAMPLE EMBODIMENTS

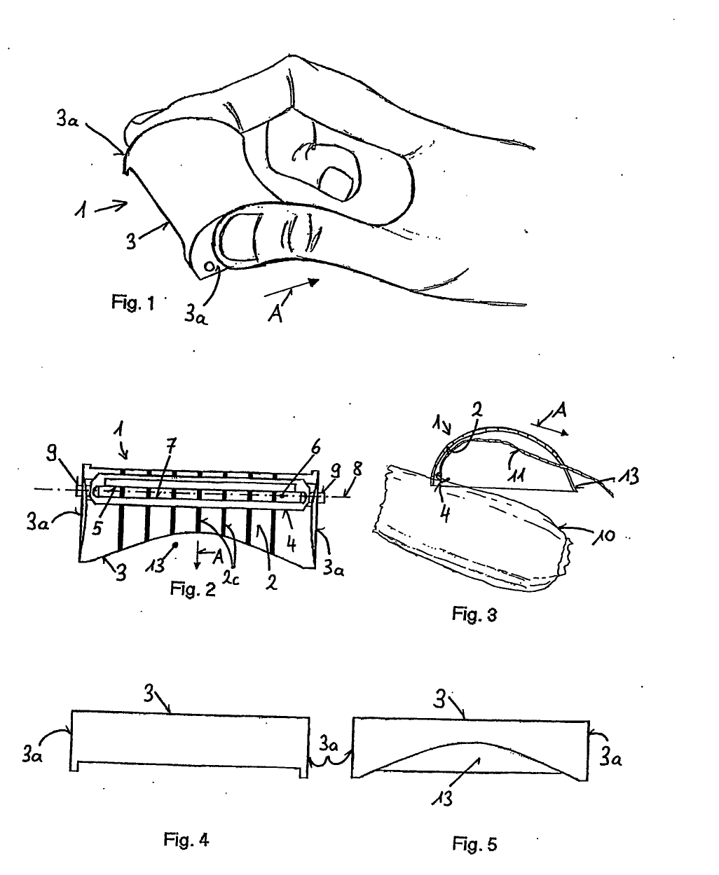

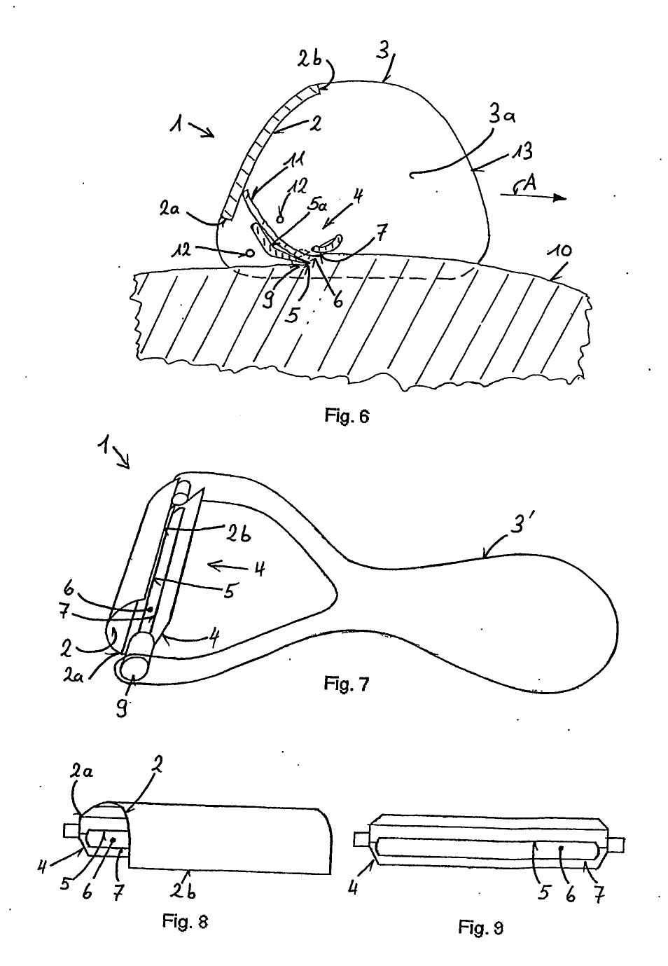

FIGS. 1 to 6 show a vegetable peeler 1 having a deviation surface 2 on a holder 3. The holder 3, apart from the deviation surface 2, comprises two lateral gripping surfaces 3a. A peeling knife 4 is pivotally held on the holder 3. The peeling knife 4 is usually an element integrally formed of metal, ceramics or plastic material. It comprises a cutting edge 5, a cutting gap 6 and an engagement line 7. The axis 8 of the peeling knife extends in longitudinal direction of the peeling knife 4 through two laterally protruding axial bearings 9 and, thus, substantially parallel to the cutting edge 5. When peeling, the peeling knife is substantially oriented in a peeling plane tangentially to the product to be peeled. The engagement line 7, prior to detaching a piece of peel 11, engages directly the free surface of the product to be peeled 10, and the cutting edge 5 is at the lower side of the detached piece of peel 11. When moving the peeling knife 4 in peeling direction A, the piece of peel 11 is lifted from the product to be peeled 10 (a vegetable or a fruit) by the cutting edge 5 and reaches the deviation surface 2 through the cutting gap 6.

The deviation surface extends from a joining line 2a up to an exit line 2b. The piece of peel abuts the deviation surface 2 between the joining line 2a and the exit line 2b. In order to prevent a downward deviation, the angle between a guiding surface 5a and the deviation surface 2, which is open to the front side and upwards, where a free peel front abuts the deviation surface 2, is at least somewhat larger than 90°. If the guiding surface 5a is curved in upward direction, the orientation of the guiding surface 5a corresponds substantially to the orientation of the of the rear end region of the guiding surface 5a in peeling direction. An angle between the deviation surface and the guiding surface depends, during peeling, also upon the selected orientation of the holder 3 and the deviation surface 2. Correspondingly, the said angle for the possible orientations of the guiding surface 5a relative to the deviation surface 2, during peeling, should be larger than 90°. In order to limit the range of orientations of the knife on the holder, at least one abutment element 12 is provided.

The deviation surface, during peeling, guides the piece of peel 11 forward, in peeling direction A. In order to enable the deviated piece of peel 11 to exit from the vegetable peeler 1, the vegetable peeler comprises an exit region 13, in peeling direction A before the peeling knife 4. Cut-off pieces of peel 11 are deviated forward by the deviation surface 2 in peeling direction A, and fall through the exit region 13 out of the vegetable peeler 1.

At the inside of the deviation surface 2, optionally, anti-friction elements 2c are either arranged or formed. Preferably fins or grooves are formed, which prevent adhering of pieces of peel.

According to FIGS. 1 to 6, the dimension of the vegetable peeler 1 in peeling direction A is smaller than in the direction of the longitudinal axis 8 of the peeling knife 4. The gripping surfaces 3a are formed in such a way that they may be clamped between the thumb and at least one finger of the user.

FIGS. 7 to 9 show a peeling knife 4 having a directly joining deviation surface 2 fastened to it. The deviation surface 2 extends from the joining line 2a up to the exit line 2b. In the area between the joining line 2a and the exit line 2b, the deviation surface 2 has an area which deviates forwards detached pieces of peel in peeling direction A. By the orientation, the shape and direct joining of the deviation surface to the peeling knife, it is ensured that no pieces of peel can reach the product to be peeled in peeling-direction behind the peeling knife. The peeling knife 4 including the deviation surface 2 is able to be inserted into conventional vegetable peelers or conventional holders 3′ so as to obtain a vegetable peeler 1 according to the invention.

Preferably, the deviation surface 2 comprises an area that is concave towards the peeling knife 4. By this concave shape towards the peeling knife 4, it is ensured that the pieces of peel 11 are securely deviated forwards in peeling direction A.

The peeling knife is preferably formed as a pendulum blade. It will be understood that it may also be firmly connected to the holder. This applies particularly for knife-shaped vegetable peelers.

1. A vegetable peeler, comprising:
a holder;
a peeling knife extended along an axis of the peeling knife and supported by the holder, the peeling knife including a cutting edge extending in a longitudinal direction, a cutting gap and an engagement line, said engagement line being formed at a side of the cutting gap opposite the cutting edges and a peeling direction, during peeling, being directed from the cutting edge towards the engagement line;
a deviation surface which, during the peeling procedure, in the peeling direction, is at least partially behind the peeling knife; and
an exit area in front of the peeling knife, so that pieces of peel cut-off are forward deviated by the deviation surface, when seen in the peeling direction, and fall through the exit area out of the vegetable peeler.

2. The vegetable peeler according to claim 1, wherein the deviation surface includes an area that is concave towards the peeling knife.

3. The vegetable peeler according to claim 1, wherein the deviation surface is arranged on the holder separated from the peeling knife.

4. The vegetable peeler according to claim 3, wherein a joining line of the deviation surface, during the peeling operation, is at the plane of the peeling knife so that a detached piece of peel reaches the deviation surface via the joining line.

5. The vegetable peeler according to claim 1, wherein the deviation surface is formed on the peeling knife.

6. The vegetable peeler according to claim 1, wherein the holder includes two lateral gripping surfaces on which the peeling knife is supported at both sides as a pendulum knife, and that the dimension of the holder, in peeling direction, is shorter than the distance between the gripping surfaces.

7. The vegetable peeler according to claim 6, wherein the deviation surface and the gripping surfaces are integrally produced from at least one of a metal and a plastic material.

8. The vegetable peeler according to claim 1, wherein anti-friction elements are arranged on the deviation surface and extend transversely to the cutting edge.

9. The vegetable peeler according to claim 1, wherein the engagement line of the peeling knife is formed as an additional cutting edge.

10. The vegetable peeler according to claim 1, wherein the cutting edge is formed as a julienne knife.

11. The vegetable peeler according to claim 1, wherein the deviation surface extends at least over a middle longitudinal range of the peeling knife.

12. The vegetable peeler according to claim 1, wherein the deviation surface extends over the entire longitudinal dimension, of the peeling knife.

13. The vegetable peeler according to claim 1, wherein the deviation surface, which in cross-sectional planes transversely to the axis of the peeling knife is limited by a joining line and an exit line turned away from the former.
